(19) United States
(12) Patent Application Publication
(10) Pub. No.: US 2009/0063240 A1
(43) Pub. Date: Mar. 5, 2009

(54) ROUTING TRANSACTIONS IN A MULTIPLE JOB ENVIRONMENT USING AN APPROVAL FRAMEWORK

(75) Inventors: Vincent Francis PALLARI, Folsom, CA (US); Shawn Michael Abernathy, Boulder Creek, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 11/847,686

(22) Filed: Aug. 30, 2007

(51) Int. Cl. G06F 9/46

(52) U.S. Cl. 705/9

(57) ABSTRACT

Approval routing and processing is provided in a multiple job environment by providing the ability to pass job information through a universal class, along with information for the employee submitting a transaction for a approval, to an Approval Framework. An engine of the Approval Framework determines whether a routing is necessary, and a user list object of the Approval Framework contains the logic necessary to determine the appropriate person to which to route the transaction, using the employee and job information for the transaction. The Approval Framework also writes the job and employee information to a database such that the logic can be reconstructed outside transaction processing or for subsequent processing, such as to determine a status or path of the approval process or to determine a subsequent person or department to approve the transaction.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates generally to managing transactions, and more particularly to routing employee transactions for approval in an enterprise environment.

As organizations continue to move to paperless systems, the complexity of managing transactions electronically within an organization increases accordingly. In many instances, existing transaction management and workflows are not sufficient to provide the functionality needed to process all variations of a transaction. For example, an employee might submit a transaction that requires approval from at least one manager, supervisor, or other appropriate person, department, etc. When an employee only has one job description or role and only works for one manager, this process is relatively straightforward as the transaction can simply be routed to that manager for approval. Problems arise, however, when the employee has multiple jobs, roles, or functions that result in multiple persons and/or entities being responsible for approving different transactions.

Further, many transactions require multiple layers of approval, and a manager making an initial approval might in turn report to more than one supervisor based upon the job or role of the manager relative to that transaction. Not only is this routing complexity not addressed in current systems, but current systems also do not provide a way to maintain job information throughout the various routing processes, as well as outside this processing, in order to make multiple routing and/or status determinations based thereon.

It therefore is desirable to provide an approach that contains enough granularity to be able to track users and transaction at the job level, wherein routing decisions can be made for users, managers, and/or other employees with multiple jobs, roles, functions, etc.

### BRIEF SUMMARY OF THE INVENTION

Systems and methods in accordance with various embodiments of the present invention provide for the routing and management of transactions utilizing a transaction management application and an Approval Framework. The Approval Framework is a universal framework capable of supporting multiple applications.

In one embodiment, a user submits a transaction that is received by the transaction management application. The transaction can be for any appropriate reason, such as to get approval for a request for time off work. The management application determines employee information identifying the user and also receives job information from the user. The user may have multiple jobs that report to multiple managers, so it is necessary to identify the job associated with the transaction in order to determine the proper routing. The application passes the employee information with the call into an object such as a UserList of the Approval Framework, and also passes a universal class such as a User Utilities Class to the Approval Framework, where the User Utilities Class contains the job information.

In one embodiment, the UserList object determines the appropriate person to which to route the transaction based on logic of the object, as well as the employee and job information. This routing information can be determined by calling into a reporting application such as a Direct Reports application. Once the routing information for the transaction is determined, the transaction is routed to the appropriate person for approval. Also, the job and employee information is written to a database for later retrieval outside the transaction processing.

When the appropriate person approves the transaction, another call is made into the Approval Framework. An Approval Framework engine determines whether another approval is needed. If so, the UserList object can extract the previous job and employee information from the database in order to determine a subsequent person to which to route the transaction for approval. Since the first person approving the transaction might also have multiple jobs reporting to multiple people, it can be necessary to again call into a Direct Reports or similar application in order to determine the proper routing information. Once the routing information is determined, the transaction is again routed to the appropriate person and the process continues until the transaction is ultimately approved or denied.

In one embodiment, a status monitor is provided that allows an employee or other authorized user to view the current path of the approval process for a transaction. Since the request to display information in a status monitor typically will occur outside of transaction processing, the UserList object can request the employee and job information from the database that is necessary to interpolate future routings for the transaction.

A further understanding of the nature and the advantages of the inventions disclosed herein may be realized by reference of the remaining portions of the specification and the attached drawings.

### BRIEF DESCRIPTION OF THE DRAWINGS

Various embodiments in accordance with the present invention will be described with reference to the drawings, in which:

FIG. 1 illustrates a system for routing and approving transactions that can be used in accordance with one embodiment of the present invention;

FIGS. 2(a) and 2(b) illustrate exemplary authorization flows that can be used in accordance with one embodiment of the present invention;

FIGS. 3(a) and 3(b) illustrate exemplary authorization flows that can be used in accordance with one embodiment of the present invention;

FIG. 4 illustrates a status monitor display that can be used in accordance with one embodiment of the present invention;

FIG. 5 illustrates steps of an exemplary process that can be used in accordance with one embodiment of the present invention;

FIG. 6 illustrates components of an exemplary operating environment that can be used in accordance with various embodiments of the present invention; and

FIG. 7 illustrates components of an exemplary computer system that can be used in accordance with various embodiments of the present invention.

### DETAILED DESCRIPTION OF THE INVENTION

Systems and methods in accordance with various embodiments can overcome the aforementioned and other deficiencies in existing transaction management systems by providing for the passing of job information, in addition to employee information, in order to properly route transactions for an employee. Further, the approach provides for storing the job information between routing decisions in order to properly make subsequent routing decisions for that transaction even though the original class may no longer be populated. These approaches can be used with a business process such as an approval process, wherein transactions are routed for approval within an organization. Such approaches also can provide a status monitor that is able to determine and display the current approval state for each such transaction outside of transaction processing.

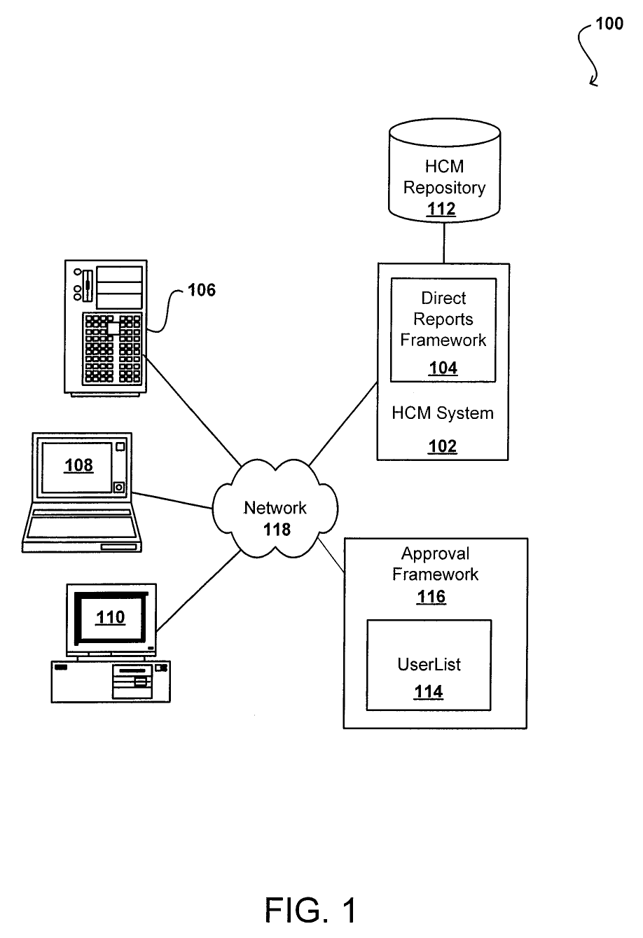

A system in accordance with one embodiment can be used with a transaction management system, such as PeopleSoft Human Capital Management (HCM) available from Oracle Corporation of Redwood Shores, Calif., which is an application for performing human resources-related functions such as tracking employee and job information. Such a system 100 is illustrated in FIG. 1. By building upon the functionality of such a system, a transaction management system can provide support for multiple jobs, wherein an employee might have multiple, concurrent employment records for multiple jobs, with each of the jobs having different job attributes, such as management structure, benefit eligibility, and cost center. In such a system, an employee transaction can be submitted by the employee through, for example, a laptop 108 or desktop computer 110, or submitted via a server 112 from a transaction application, where the transaction passes through an appropriate network 118 and is received by the HCM system 102. An HCM system stores information in an HCM repository 112 and includes a Direct Reports framework 104. The Direct Reports framework includes specific functionality for determining organizational relationships. In one example, a Direct Reports framework allows customers or organizations to define employee/manager relationships from access types such as Supervisor, Department, Position, Partial-Position-Supervisor, and Partial Position-Department. The HCM system also can include a Direct Reports interface (not shown), such as a common API capable of encapsulating common logic for determining direct reports, which is able to determine direct reports for a given employee or to determine the person or entity to which an employee or job directly reports.

In one example of a Direct Reports framework, an access type is by an identifier such as supervisor ID. Within the database, organizations can define relationships by explicitly defining a supervisor for an employee, by creating departments and placing employees in those departments with a manager being assigned to each department, or any other appropriate approach. Relationships also can be defined via positions, where a developer position and a development manager position are assigned, and those two positions report to one another.

The exemplary system 100 also includes an Approval Framework 116, which is a common framework that sits outside the HCM system into which transactions in the HCM system can call. The Approval Framework can support many applications including and in addition to the HCM system, and can be used to define and route transactions that require approvals, for example. The Approval Framework can include an Approval Workflow Engine (AWE) that provides the capability and framework for creating, running, and managing approval processes. The engine can use a series of database objects combined with application component configuration settings to determine how to process approvals using workflows. Approval workflows are triggered when requesters submit a transaction. The application passes the transaction over to the AWE, which finds the appropriate approval process definition and launches the approval workflow. A set of approvers than carry out tasks related to the transaction.

The AWE allows multiple levels of users to develop, configure, and use transaction approvals that meet organizational requirements. In order to provide such functionality to an application, the application must implement or integrate the Approval Framework in order to leverage the functionality. Application developers register the application with the AWE and describe the application components, event handler, and records, for example. The developer also can create a record and table in which to store cross-reference information and set up notification templates for events. The application then must make specific calls into the Approval Framework. When a user submits a transaction for approval, the action launches the approval process whereby the AWE reads an approval process definition and queues the transaction for approval. An Approval Process Definition is defined by a developer to include items such as stages, paths, steps, varying hierarchies, and criteria, among other configurable parameters. Each Approval Process Definition includes a process identifier (ID) that is registered with the AWE.

The AWE in one embodiment utilizes “User Lists”, with a UserList 114 being a standalone, user-defined object owned within the Approval Framework that is operable to be used to build groups of users. A UserList can accept information for one or more users and return information for one or more users. A UserList can be defined using any appropriate technology, such as by using SQL to query the HCM repository and return users, by pointing the object directly to a system role, or by utilizing particular application classes. Once defined, a UserList can be called upon to execute logic defined within that UserList to return a group of users. UserLists can be invoked several times throughout the approval process in order to determine the appropriate participant for a particular step. In one embodiment, users can be encapsulated into a role, wherein a request for an administrator role or HCM manager role will return a list of those users from the appropriate UserList. Embodiments providing for the use of application classes allows an organization to generate any appropriate logic to pull information from the database and determine users based on any appropriate condition or parameter value.

In one embodiment, the HCM application and Approval Framework work together as follows. The HCM application includes multiple jobs functionality and Direct Reports functionality. The multiple jobs and Direct Reports functionality interact with HCM transactions, such as an absence management (AM) transaction allowing employees to request time off, and a recruiting solution (RS) transaction for managing internal and external recruiting, including such functionality as accepting resumes and granting jobs. The HCM transactions are able to call the Approval Framework outside of HCM.

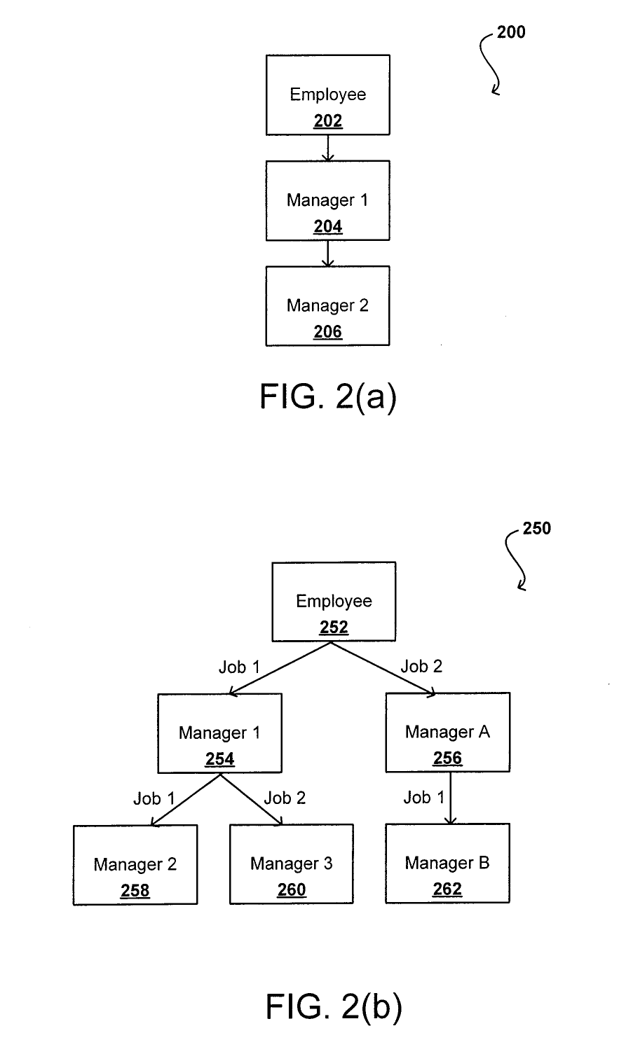

As discussed above, such a system can provide the flexibility needed to process transactions in a multiple job environment. For some cases, such as the approval flow 200 of FIG. 2(a), an Employee 202 has a single job and reports only to Manager 1 204, who in turn reports to Manager 2 206. In such a case, a routing decision is easy as a transaction submitted by the Employee requires a first approval from Manager 1 and a second approval from Manager 2.

The routing is significantly more complicated in the approval flow 250 of FIG. 2(b). In this example an Employee 252 has two jobs, with Job 1 reporting to Manager 1 254 and Job 2 reporting to Manager A 256. Manger 1 in turn has two jobs, with Job 1 reporting to Manager 2 258 and Job 2 reporting to Manager 3 260. Manager A only has Job 1 that reports to Manager B 262. For any transaction submitted to the HCM system for this employee, the logic behind the transaction will pass on employee information for the employee to the Approval Framework. The Approval Framework takes that employee information and an engine of the Approval Framework determines whether a routing is necessary. If so, the information is passed into a UserList, the logic of which will determine the appropriate manager to which the transaction should be routed for approval. A subsequent call to into a UserList will be needed to determine the subsequent manager to which to route the transaction approved by the first manager receiving the transaction.

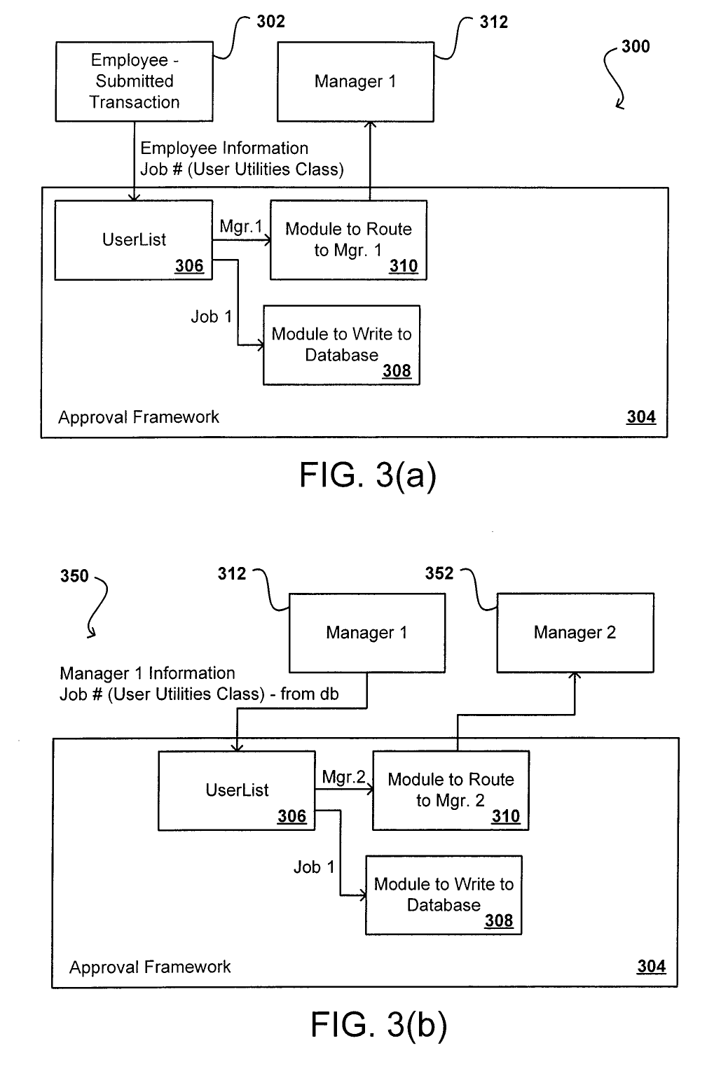

FIGS. 3(a) and 3(b) demonstrate an exemplary flow of calls and processes for the reporting tree of FIG. 2(b). In a first portion 300 of this process, an employee-submitted transaction 302 calls into the Approval Framework 304. An appropriate UserList 306, specified by the call, receives as input Employee Information for the employee submitting the transaction, and a User Utilities Class including Job Information, such as a Job Number. The User Utilities Class resides in an interface above the Approval Framework, and provides the ability to pass job (and other appropriate) information to the Approval Framework. A User List 306 thus takes an array or set of Users and the Utilities Class as inputs during transaction processing (e.g., Submit or Approve actions), processes this information using logic defined for that User List, and returns an array or set of users. In one embodiment, the UserList takes the employee and job information and queries Direct Reports to determine the appropriate supervisor, etc., to which to route the transaction for approval. The User List process thus determines the appropriate manager to receive the transaction. In this example, the UserList determines that the transaction should be routed to Manager 1. Once the determination is made, information about the job is passed to a module 308 operable to write the job information to memory, such as resident memory or persistent storage. Information identifying Manager 1 is passed to a module 310 for routing the transaction to Manager 1 312, who then can approve or deny the transaction. In some systems, the manager also can have the ability to request additional information before deciding.

In a second portion 350 of this process, once Manager 1 312 approves the transaction, another call is made into the Approval Framework 304. An appropriate UserList 306, specified by the call, receives as input Manager Information for the manager submitting the transaction, here Manager 1, and a User Utilities Class including Job Information. In order to obtain the Job information, which would no longer be populated in the User Utilities Class after the first routing, the HCM system can read the information from memory and pass the Job information to the Approval Framework. A User List 306 again processes the information and determines the appropriate manager to receive the transaction. In this example, the Approval Framework engine determines that another routing is necessary, and the UserList determines that the already once-approved transaction should now be routed to Manager 2 352. Once the determination is made, information about the job for Manager 2 is passed to a module 308 operable to store the job information. Information identifying Manager 2 is passed to a module 310 in the Approval Framework for routing the transaction to Manager 2 352, who then also can approve or deny the transaction. Both Manager 1 and Manager 2 must approve the transaction in this example, in order for the transaction to be finally approved. Once Manager 2 approves the transaction, another call is made into the Approval Framework and the transaction is deemed complete by the Approval Framework.

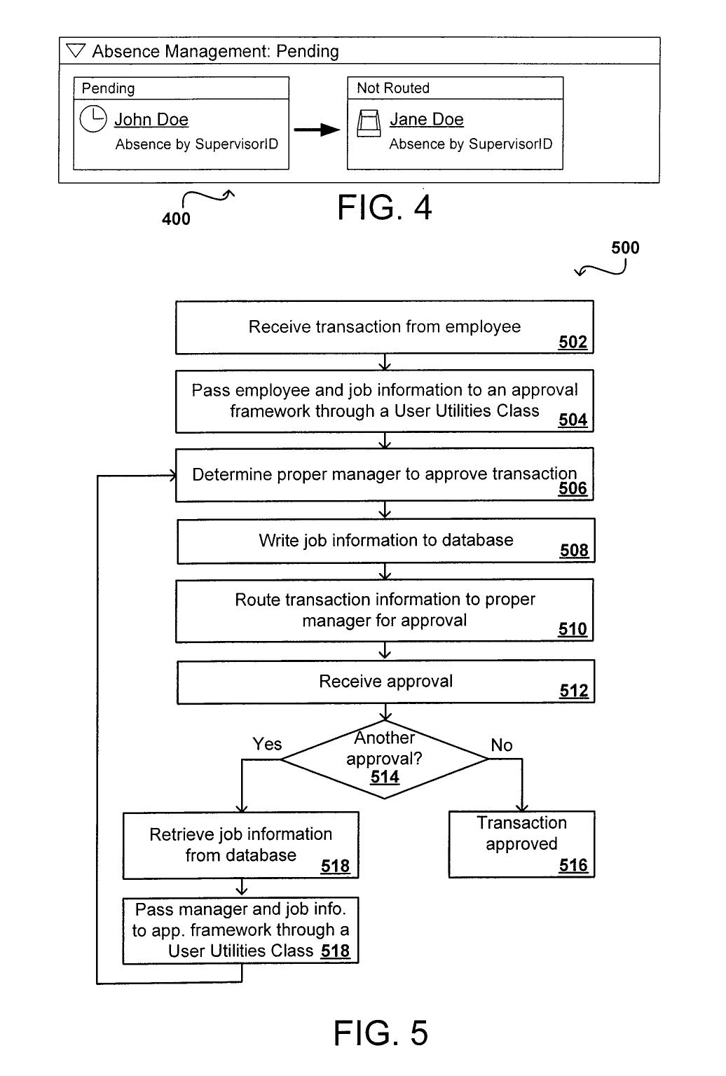

FIG. 4 illustrates an exemplary status monitor display 400 that can be used with the system to provide the employee or another appropriate user with current status information for the transaction. The status monitor can provide an online, graphical representation of the approval process. When an employee submits a transaction, the employee can immediately get confirmation that the transaction has been submitted, and that the transaction is sitting with the appropriate manager, and can see the overall approval state and/or path. Approval states can include, for example, Pending, Denied, Approved, Awaiting Further Approvals, etc. After the first manager approves the transaction, the status monitor will be updated to show that the transaction is sitting with the second manager awaiting approval, and so on. Since the status monitor can be accessed at any time, the UserList providing the information might be executing outside of the transaction processing. The User Utilities Class is only alive when processing the transaction, however, such that the job information is not still resident in the User Utilities Class. Since the information was written to the database, however, the Approval Framework receives the job information from the database in order to determine the appropriate status information to display to the user. In one embodiment, the employee and job information is written to the database each time a UserList is processed. In this way, when the UserList is executed outside transaction processing, the stored data record provides the information necessary to reconstruct the logic for determining the routing for the transaction and interpolating subsequent steps in the process.

In one embodiment, the UserList processing logic includes multiple processing branches. If, when executing the UserList, the user and job information is passed to the Approval Framework, the UserList knows the identity of the employee at runtime, and know which job the employee is submitting the transaction under, such that the UserList can easily determine the routing. If the user information is provided without job input information, such as when a request for a status monitor is received, only the user information is provided such that the record in the database has to be accessed to determine the job information to reconstruct the logic needed to determine the information needed to display a visual representation of the approval chain.

In some cases the database may not contain the necessary information, such as where a manager has not previously processed a transaction through the Approval Framework. In such a case, the information from the previous step in the approval process can be examined and the UserList can query Direct Reports to determine the job for which the user in a previous step submitted the transaction, and determine the job of the current manager to which that employee reports. If this information cannot be obtained from Direct Reports, the user's primary job can be used as a default to attempt to route the transaction to the appropriate person to approve that step in the process.

FIG. 5 illustrates steps of an exemplary process 500 that can be used in accordance with one embodiment of the present invention. In this process, a transaction management application receives an employee-submitted transaction 502. Job information for the employee transaction is added to a User Utilities Class, such that the employee and job information for the employee transaction can be submitted to a User List object of an Approval Framework 504. In one embodiment, the transaction calls into the Approval Framework passing with the call the job information and the User Utilities Class containing the job information. The logic behind the User List determines the proper manager to which to route the transaction for approval 506. The employee and job information is written to a database 508 and the transaction is routed to the determined manager 510. An approval (or denial) then is received from the manager 512. If the transaction is approved, a determination is made as to whether another approval is needed for the transaction 514. If another transaction is not needed, the transaction can be determined to be finally approved 516. If another approval is needed, the employee, manager, and job information is retrieved from the database and the information is again passed to a UserList object via an appropriate call 518 so that a subsequent routing determination 506 can be made. The process continues until a transaction is denied or until all necessary persons approve the transaction.

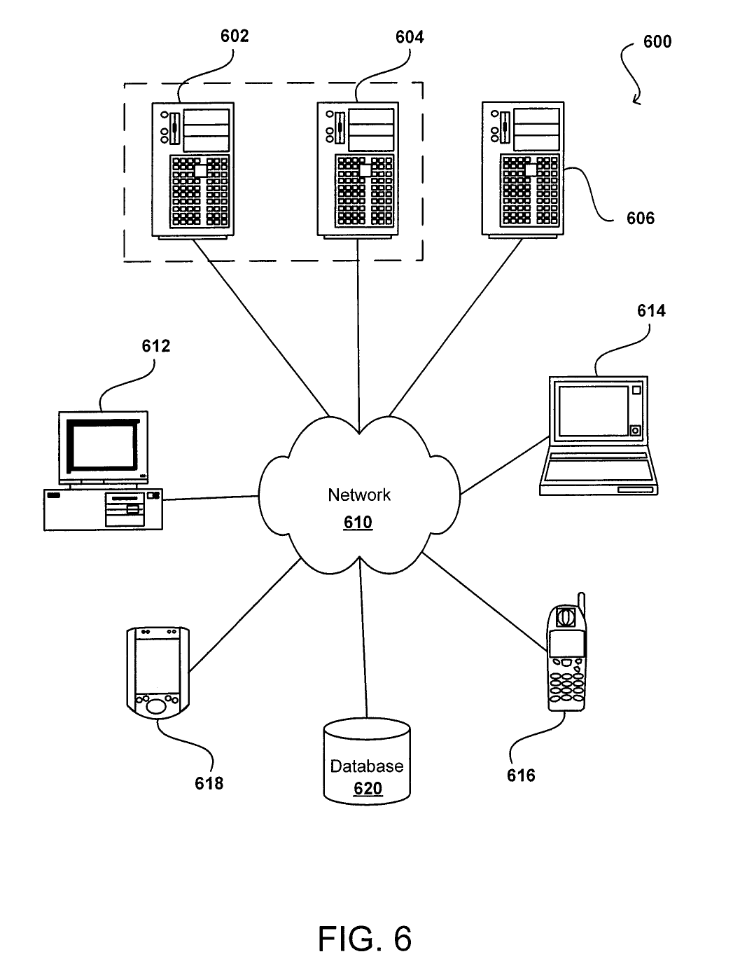

FIG. 6 is a block diagram illustrating components of an exemplary operating environment in which various embodiments of the present invention may be implemented. The system 600 can include one or more user computers, computing devices, or processing devices 612, 614, 616, 618, which can be used to operate a client, such as a dedicated application, web browser, etc. The user computers 612, 614, 616, 618 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 612, 614, 616, 618 may also have any of a variety of applications, including one or more development systems, database client and/or server applications, and Web browser applications. Alternatively, the user computers 612, 614, 616, 618 may be any other electronic device, such as a thin-client computer, Internet-enabled gaming system, and/or personal messaging device, capable of communicating via a network (e.g., the network 610 described below) and/or displaying and navigating Web pages or other types of electronic documents. Although the exemplary system 600 is shown with four user computers, any number of user computers may be supported.

In most embodiments, the system 600 includes some type of network 610. The network may be any type of network familiar to those skilled in the art that can support data communications using any of a variety of commercially-available protocols, including without limitation TCP/IP, SNA, IPX, AppleTalk, and the like. Merely by way of example, the network 610 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 602, 604, 606 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 606) may be dedicated to running applications, such as a business application, a Web server, application server, etc. Such servers may be used to process requests from user computers 612, 614, 616, 618. The applications can also include any number of applications for controlling access to resources of the servers 602, 604, 606.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 612, 614, 616, 618. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 612, 614, 616, 618.

The system 600 may also include one or more databases 620. The database(s) 620 may reside in a variety of locations. By way of example, a database 620 may reside on a storage medium local to (and/or resident in) one or more of the computers 602, 604, 606, 612, 614, 616, 618. Alternatively, it may be remote from any or all of the computers 602, 604, 606, 612, 614, 616, 618, and/or in communication (e.g., via the network 610) with one or more of these. In a particular set of embodiments, the database 620 may reside in a storage-area network (“SAN”) familiar to those skilled in the art. Similarly, any necessary files for performing the functions attributed to the computers 602, 604, 606, 612, 614, 616, 618 may be stored locally on the respective computer and/or remotely, as appropriate. In one set of embodiments, the database 620 may be a relational database, such as Oracle 10g, that is adapted to store, update, and retrieve data in response to SQL-formatted commands.

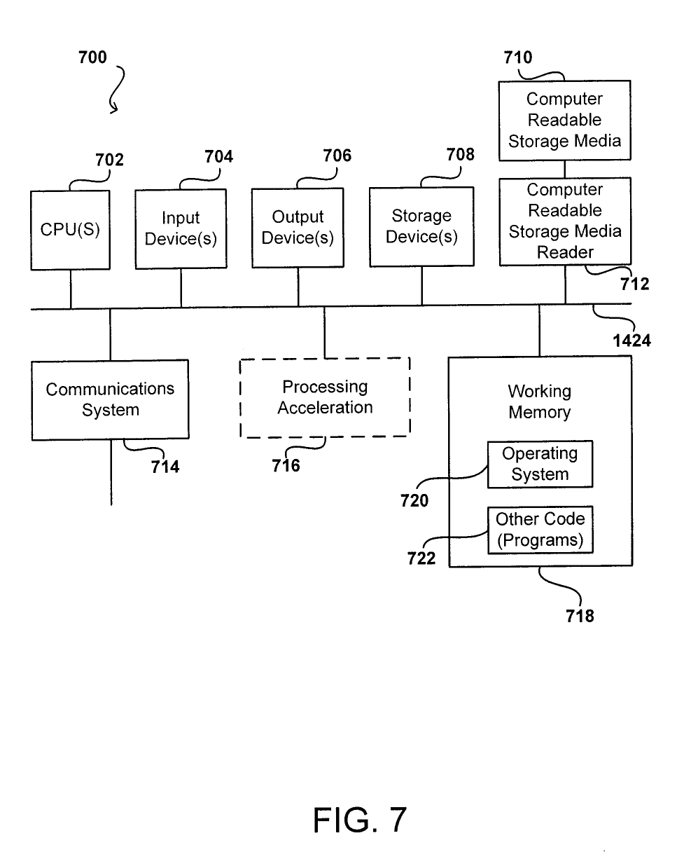

FIG. 7 illustrates an exemplary computer system 700, in which various embodiments of the present invention may be implemented. The system 700 may be used to implement any of the computer systems described above. The computer system 700 is shown comprising hardware elements that may be electrically coupled via a bus 724. The hardware elements may include one or more central processing units (CPUs) 702, one or more input devices 704 (e.g., a mouse, a keyboard, etc.), and one or more output devices 706 (e.g., a display device, a printer, etc.). The computer system 700 may also include one or more storage devices 708. By way of example, the storage device(s) 708 can include devices such as disk drives, optical storage devices, solid-state storage device such as a random access memory (“RAM”) and/or a read-only memory (“ROM”), which can be programmable, flash-updateable and/or the like.

The computer system 700 may additionally include a computer-readable storage media reader 712, a communications system 714 (e.g., a modem, a network card (wireless or wired), an infra-red communication device, etc.), and working memory 718, which may include RAM and ROM devices as described above. In some embodiments, the computer system 700 may also include a processing acceleration unit 716, which can include a digital signal processor DSP, a special-purpose processor, and/or the like.

The computer-readable storage media reader 712 can further be connected to a computer-readable storage medium 710, together (and, optionally, in combination with storage device(s) 708) comprehensively representing remote, local, fixed, and/or removable storage devices plus storage media for temporarily and/or more permanently containing, storing, transmitting, and retrieving computer-readable information. The communications system 714 may permit data to be exchanged with the network and/or any other computer described above with respect to the system 700.

The computer system 700 may also comprise software elements, shown as being currently located within a working memory 718, including an operating system 720 and/or other code 722, such as an application program (which may be a client application, Web browser, mid-tier application, RDBMS, etc.). It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method of routing transactions for approval, comprising:
receiving a transaction for approval, the transaction being submitted by an employee having more than one job and reporting to more than one manager;
passing employee information and job information into an object containing logic to determine routing information for the transaction, the job information being passed through a universal class into the object, the employee information identifying the employee and the job information identifying which of the jobs of the employee correspond to the transaction;
determining an appropriate person to which to route the transaction for approval using the employee and job information with the logic of the object; and
routing the transaction to the appropriate person for approval.

2. A method according to claim 1, further comprising:
writing the job information and employee information to a database after determining the appropriate person to which to route the transaction.

3. A method according to claim 2, further comprising:
receiving information for the transaction from the approved person, the information including one of an approval and a denial for the transaction;
for an approved transaction, determining whether another approval is needed; and
where another approval is needed, reading the job and employee information from the database and determining a subsequent person to which to route the transaction for approval, the transaction then being routed to the subsequent person.

4. A method according to claim 1, further comprising:
providing a status monitor display indicating a current approval state for the transaction.

5. A method according to claim 4, further comprising:
receiving a request for the status monitor display;
reading the employee information and job information from the database;
determining the current approval state for the transaction; and
displaying the current approval state in the status monitor display.

6. A method according to claim 1, wherein:
the appropriate person also has more than one job and reports to more than one manager.

7. A method according to claim 1, further comprising:
providing an Approval Framework operable to communicate with multiple applications and provide the object for determining routing.

8. A method according to claim 1, wherein:
the object is a User List object.

9. A method according to claim 1, wherein:
the universal class is a User Utilities Class.

10. A system for routing transactions for approval, the system including a processor operable to execute instructions and a data storage medium for storing the instructions which, when executed by the processor, cause the processor to:
receive a transaction for approval, the transaction being submitted by an employee having more than one job and reporting to more than one manager;
pass employee information and job information into an object containing logic to determine routing information for the transaction, the job information being passed through a universal class into the object, the employee information identifying the employee and the job information identifying which of the jobs of the employee correspond to the transaction;
determine an appropriate person to which to route the transaction for approval using the employee and job information with the logic of the object; and
route the transaction to the appropriate person for approval.

11. A system according to claim 10, wherein the instructions which, when executed by the processor, further cause the processor to:
write the job information and employee information to a database after determining the appropriate person to which to route the transaction.

12. A system according to claim 11, wherein the instructions which, when executed by the processor, further cause the processor to:
receive information for the transaction from the approved person, the information including one of an approval and a denial for the transaction;
for an approved transaction, determine whether another approval is needed; and
where another approval is needed, read the job and employee information from the database and determine a subsequent person to which to route the transaction for approval, the transaction then being routed to the subsequent person.

13. A system according to claim 10, wherein the instructions which, when executed by the processor, further cause the processor to:
provide a status monitor display indicating a current approval state for the transaction.

14. A system according to claim 13, wherein the instructions which, when executed by the processor, further cause the processor to:
receive a request for the status monitor display;
read the employee information and job information from the database;
determine the current approval state for the transaction; and
display the current approval state in the status monitor display.

15. A system according to claim 10, wherein the instructions which, when executed by the processor, further cause the processor to:
provide an Approval Framework operable to communicate with multiple applications and provide the object for determining routing.

16. A computer program product embedded in a computer readable medium for routing transactions for approval, comprising:
program code for receiving a transaction for approval, the transaction being submitted by an employee having more than one job and reporting to more than one manager;
program code for passing employee information and job information into an object containing logic to determine routing information for the transaction, the job information being passed through a universal class into the object, the employee information identifying the employee and the job information identifying which of the jobs of the employee correspond to the transaction;
program code for determining an appropriate person to which to route the transaction for approval using the employee and job information with the logic of the object; and
program code for routing the transaction to the appropriate person for approval.

17. A computer program product according to claim 16, further comprising:
program code for writing the job information and employee information to a database after determining the appropriate person to which to route the transaction.

18. A computer program product according to claim 17, further comprising:
program code for receiving information for the transaction from the approved person, the information including one of an approval and a denial for the transaction;
program code for determining whether another approval is needed for an approved transaction; and
program code for reading the job and employee information from the database and determining a subsequent person to which to route the transaction for approval, the transaction then being routed to the subsequent person, where another approval is needed.

19. A computer program product according to claim 16, further comprising:
program code for providing a status monitor display indicating a current approval state for the transaction.

20. A computer program product according to claim 19, further comprising:
program code for receiving a request for the status monitor display;
program code for reading the employee information and job information from the database;
program code for determining the current approval state for the transaction; and
program code for displaying the current approval state in the status monitor display.

21. A computer program product according to claim 16, further comprising:
program code for providing an Approval Framework operable to communicate with multiple applications and provide the object for determining routing.
